(19) United States
(12) Patent Application Publication
(10) Pub. No.: US 2019/0237067 A1
(43) Pub. Date: Aug. 1, 2019

(54) MULTI-CHANNEL VOICE RECOGNITION FOR A VEHICLE ENVIRONMENT

(71) Applicant: Toyota Motor Engineering & Manufacturing North America, Inc., Erlanger, KY (US)

(72) Inventors: Scott A. Friedman, Dallas, TX (US); Prince R. Remegio, Lewisville, TX (US); Tim Uwe Falkenmayer, Mountain View, CA (US); Roger Akira Kyle, Lewisville, TX (US); Ryoma Kakimi, Ann Arbor, MI (US); Luke D. Heide, Plymouth, MI (US); Nishikant Narayan Puranik, Frisco, TX (US)

(21) Appl. No.: 15/884,437

(22) Filed: Jan. 31, 2018

(51) Int. Cl. G10L 15/22; H04R 1/40; G10L 15/08; H04R 3/00

(52) U.S. Cl. CPC G10L 15/22; H04R 1/406; G10L 15/08; H04R 2499/13; G10L 2015/086; G10L 2015/223; H04R 3/005

(57) ABSTRACT

A method and device for providing voice command operation in a passenger vehicle cabin having multiple occupants are disclosed. The method and device operate to monitor microphone data relating to voice commands within a vehicle cabin and determine whether the microphone data includes wake-up-word data. When the wake-up-word data relates to more than one of a plurality of vehicle cabin zones and more than one wake-up-words are coincident, the method and device operate to monitor respective microphone data for voice command data from each of the more than one of the respective ones of the plurality of vehicle cabin zones. Upon detection, the voice command data may be processed to produce respective vehicle device commands and the vehicle device command(s) can be transmitted to effect the voice command data.

### FIELD

The subject matter described herein relates in general to environmental cabin comfort devices for hybrid vehicles and, more particularly, to hybrid-vehicle climate control systems to mitigate an electric load of such systems during low-power operational modes.

### BACKGROUND

Generally, voice commands have been used in a vehicle for control of vehicle electronics, such as navigation, entertainment systems, climate control systems, and the like. When a single individual has been in the vehicle, control of the various vehicle devices has not been an issue. However, when more individuals are riding in a vehicle, voice commands may overlap with one another and be intermingled with conversation, causing a voice command to be lost or dropped in the mix. Even when voice commands can be detected, they may be buffered and processed in the order that is dictated by a system. Accordingly, chaos may increase as individuals mistake a delay in their command not being picked up, causing more repetition and confusion within the vehicle system to provide the desired voice commands being carried out.

### SUMMARY

Described herein are various embodiments of devices and methods for a vehicle cabin to provide voice command functionality with multiple coincident wake-up-words.

In one implementation, a method is provided that includes monitoring microphone data relating to voice commands within a vehicle cabin, and determining whether the microphone data includes wake-up-word data. When the wake-up-word data relates to more than one of a plurality of vehicle cabin zones, and that the more than one wake-up-words are coincident, the method includes monitoring respective microphone data for voice command data from each of the more than one of the respective ones of the plurality of vehicle cabin zones. Upon detection, the voice command data may be processed to produce respective vehicle device commands. The vehicle device command(s) may be transmitted to effect the voice command data.

In another implementation, a voice command control unit is provided that includes a communication interface, a processor and memory. The communication interface may operate to service communication with a vehicle network. The processor may communicably coupled to the communication interface. The memory is communicably coupled to the processor and stores a voice command activation module and a voice command module. The voice command activation module includes instructions that, when executed by the processor, cause the processor to monitor microphone data produced by each of respective ones of a plurality of microphones located in a vehicle cabin and determine whether the microphone data for the each of the respective ones of the plurality of microphones includes wake-up-word data. When more than one of the respective ones of the plurality of microphones include wake-up-word data, the processor is caused to receive the wake-up word data for the respective ones of the plurality of microphones, determine whether the wake-up-word data of the more than one of the respective ones of the plurality of microphones coincide with one another in time. When the wake-up-word data of the more than one of the respective ones of the plurality of microphones coincide with one another in time, the voice command activation module includes instructions that cause the processor to produce a multiple wake-up-word signal. The voice command module also includes instructions that, when executed by the processor, cause the processor to monitor the microphone data, based on the multiple wake-up-word signal, for voice command data from the each of the more than one of the respective ones of the plurality of microphones. Upon detecting the voice command data from the more than one of the respective ones of the plurality of microphones, the voice command activation module includes instructions that cause the processor to process the voice command data to produce respective vehicle device commands, and transmit, via a vehicle network, the respective vehicle device commands for effecting the voice command data from the more than one of the respective ones of the plurality of microphones.

### BRIEF DESCRIPTION OF THE DRAWINGS

The description makes reference to the accompanying drawings wherein like reference numerals refer to like parts throughout the several views, and wherein:

FIG. 1 illustrates an example block diagram of a vehicle with a voice command control unit for providing multi-zone voice command capability;

FIG. 2 illustrates another example block diagram of a vehicle with a voice command control unit for providing multi-zone voice command capability;

FIG. 3 illustrates an example of voice command communication traffic between vehicle cabin zones and the voice command control unit of FIGS. 1 and 2;

FIG. 4 illustrates a block diagram of the voice command control unit of FIGS. 1 and 2;

FIG. 5 illustrates a functional block diagram of the voice command control unit for generating vehicle device commands from voice commands having coincident wake-up-words provided via microphone data; and

FIG. 6 is an example process for voice command recognition in a vehicle cabin environment based on coincident wake-up-words.

### DETAILED DESCRIPTION

Described herein are embodiments of a device and method for distinguishing overlapping voice commands inside a vehicle environment from general conversation. In this regard, the embodiments may operate to process overlapping commands generally in parallel, providing convenience and responsiveness to voice commands.

For example, the device and method may operate to monitor microphone data relating to voice commands within a vehicle cabin and determine whether the microphone data includes wake-up-word data. When the wake-up-word data relates to more than one of a plurality of vehicle cabin zones, and when the wake-up-word data of the more than one of the respective ones of the plurality of vehicle cabin zones coincide with one another in time, the device and method monitor respective microphone data for voice command data from each of the more than one of the respective ones of the plurality of vehicle cabin zones. Upon detection, the voice command data are processed to produce respective vehicle device commands, which may be transmitted, via a vehicle network. The respective vehicle device commands are for effecting the voice command data from the more than one of the respective ones of the plurality of vehicle cabin zones.

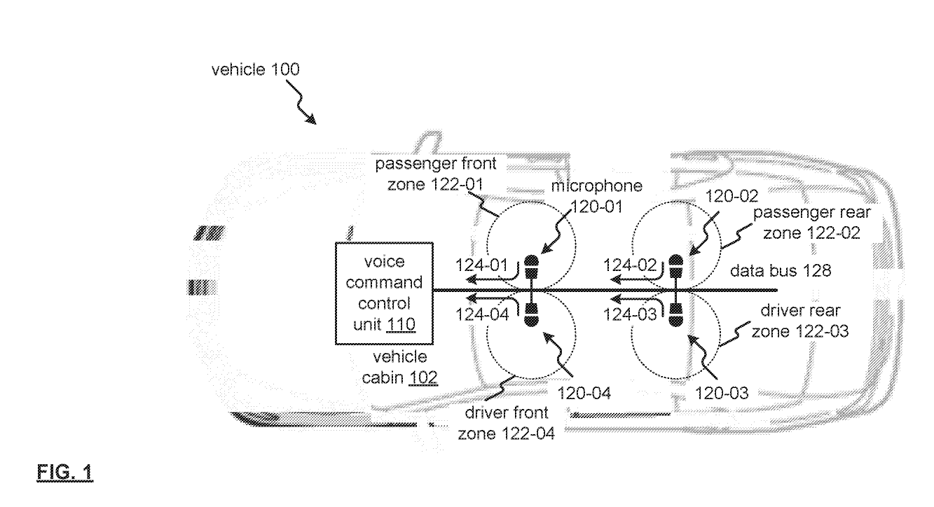

FIG. 1 illustrates a block diagram of a vehicle 100 with a voice command control unit 110 coupled with a plurality of microphones 120-01, 120-02, 120-3, and 120-04 for providing multi-zone voice command capability. The vehicle 100 may be a passenger vehicle, a commercial vehicle, a ground-based vehicle, a water-based vehicle, and/or and air-based vehicle.

The vehicle 100 may include microphones 120-01 through 120-04 positioned within the vehicle cabin 102. The microphones 120-01 through 120-04 each have a sensitivity that may define respective zones, such as passenger front zone 122-01, a passenger rear zone 122-02, a driver rear zone 122-03, and a driver front zone 122-4. The zones represent a proximal area and/or volume of the vehicle cabin 102 that may relate to a vehicle passenger and/or vehicle operator.

The number of zones may increase or decrease based on the number of possible passengers for a vehicle 100. For example, the vehicle 100 may have four passengers that may issue voice commands for operation of vehicle electronics, such as an entertainment system, HVAC settings (such as increasing/decreasing temperature for the vehicle cabin 102), vehicle cruise control settings, interior lighting, etc.

The microphones 120-01 to 120-04 may operate to receive an analog input, such as a wake-up-word and voice command and produce, via analog-to-digital conversion, a digital data output, such as microphone data 124-01, 124-02, 124-03 and 124-04, respectively. A zone may be identified with respect to the source of the wake-up-word. For example, a passenger issuing a wake-up-word from the passenger rear 122-02 may be proximal to the microphone 120-02. Though a wake-up-word may be sensed by other microphones within the vehicle cabin 102, the proximity may be sensed via the microphone that may operate the respective zone 122.

For voice commands, a wake-up-word may operate to activate voice command functionality. For example, a default wake-up-word may be “wake up now.” A customized wake-up-word may be created based on user preference, such as “Hello Toyota.” The wake-up-word may be used within the vehicle cabin 102 to permit any passenger to activate a voice command functionality of the vehicle 100.

In current systems, when there are multiple passengers, the noise level may be excessive within the vehicle and/or multiple passengers, including the driver, may utter the wake-up-word. In such an instance, a voice command unit may either become confused as to which zone may be the source of the wake-up word, may intermingle a subsequent voice command with the incorrect zone (for example, a wake-up-word may issue in the driver front zone 122-04, but a voice command may be received in error from passenger rear zone 122-02 by another vehicle passenger. On the other hand, as set forth in the embodiments described herein, proximity sensing by the microphones 120-01 to 120-04 operates to avoid such confusion. Also, when a microphone 120-01 to 120-04 may not be actively listening for a voice command following a respective wake-up-word, the remaining microphone inputs may operate to provide noise cancellation effects for the actively “listening” microphone.

Further, in current systems, when multiple instances of a wake-up-word coincide in time with each other, such as a wake-up-word being detected in passenger rear zone 122-02 via microphone 120-02 and also detected in passenger front zone 122-01 via microphone 120-01, processing may occur serially. In this example, the “first received” wake-up-word may be the “first out,” so that, in some instances, one of the passengers may need to repeat their voice command upon realizing their command had not been properly received. In other instances, processing of the voice command uttered by a passenger may be delayed and not be acted upon in an expedient manner. In this respect, one of the passengers may be frustrated by the inconvenience and repeat the voice command which may further add to the noise condition in the vehicle cabin 102.

On the other hand, as set forth in the embodiments described herein, the voice command control unit 110 may operate to provide substantially parallel and/or simultaneous processing of voice commands from multiple zones by monitoring the microphone data 124-01 to 124-04. When wake-up-word data of more than one of the respective ones of the vehicle cabin zones coincide with one another in time, the voice command control unit 110 may operate to monitor respective microphone data 124-01 to 124-04 for voice command data from each of the more than one of the respective ones of the vehicle cabin zones 122-01 to 122-04. Upon detection of the voice command data, the voice command control unit 110 may operate to process the voice command data to produce respective vehicle device commands, and transmit, via a vehicle network, the respective vehicle device commands for effecting the voice command data from the more than one of the respective ones of the plurality of vehicle cabin zones.

As an example, the voice command control unit 110 may determine that microphone data 124-01 relating to passenger front zone 122-01 and microphone data 124-03 relating to the driver rear zone 122-03 includes wake-up-word data (such as “wake up,” “Hello Toyota,” etc.). The voice command control unit 110 may operate to determine whether the wake-up-word data for each of the passenger front zone 122-01 and the driver rear zone 122-03 coincide with one another in time. The voice command control unit 110 may then operate to monitor the respect zones 122-01 and 122-03 for voice commands. That is, the voice command control unit 110 may operate to direct resources for processing the coinciding voice commands from the zones substantially in parallel.

With respect to the example of, the voice command control unit 110 may operate to designate data channels for the passenger front zone 122-01 and driver rear zone 122-03 as live data channels, while data channels of the remaining vehicle cabin zones are designated as dead, or inactive data channels. Further, the voice command control unit 110 may operate to discard microphone data for the remainder of the vehicle cabin zones. For example, the microphone data 124-02 and 124-04 may be discarded because they are not an active channel being monitored by the voice command control unit 110 for voice commands.

As noted, the voice commands associated with a wake-up-word may be processed to produce respective vehicle device commands. Examples of processing may include a master/slave operation, a symmetric multiprocessing operation, a massively parallel processing operation, etc.

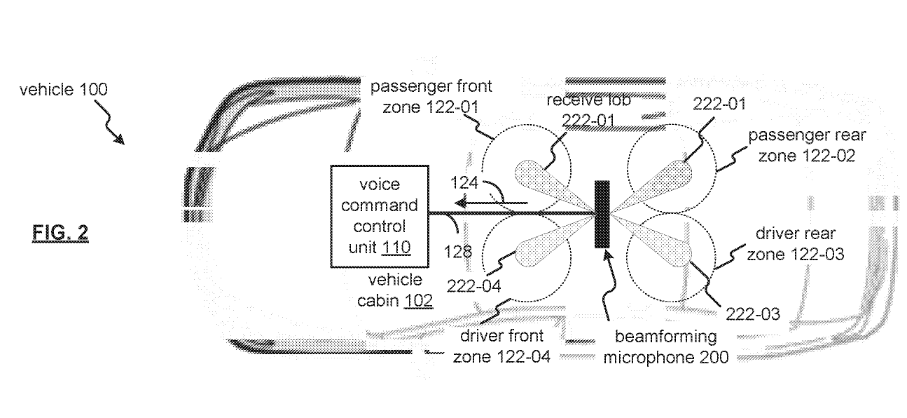

FIG. 2 illustrates a block diagram of a vehicle 100 with a voice command control unit 110 coupled with a beamforming microphone 200 for providing multi-zone voice command capability. In this respect, various microphone technologies may be used to provide the method and device described herein.

The beamforming microphone 200 may deploy multiple receive lobs 222-01, 222-02, 222-03 and 222-04, or directional audio beams, for covering the vehicle cabin 102. A DSP processor may be operable to process each of the receive lobs 222-01 to 222-04 and may include echo and noise cancellation functionality for excessive noise. The number of zones may be fewer or greater based on the occupancy capacity of the vehicle cabin 102.

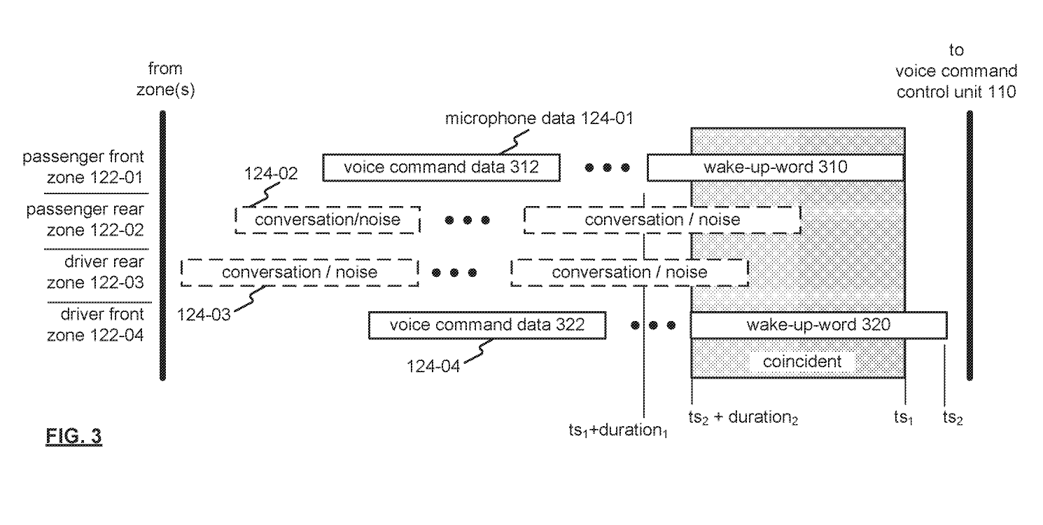

FIG. 3 illustrates an example of voice command communication traffic between zones 122-01, 122-02, 122-03 and 122-04 and the voice command control unit 110. Generally, when a vehicle cabin is carrying passengers, other sounds are present other than wake-up-words and voice commands. Other sounds may include conversations, reflected sounds (from the interior surfaces), road noise from outside the vehicle, entertainment system noise (such as music, audio and/or video playback), etc. The other sounds may also have varying amplitude levels, such as music that is played back at a loud level, conversations that may be loud due to the loud level of music in addition to a passenger that may be attempting to issue a voice command to a vehicle component.

The example of FIG. 3 illustrates various channels, which may be physical channels and/or virtual channels, for conveying information data. The voice command control unit 110 may operate to monitor microphone data 124-01, 124-02, 124-03, 124-04, and determine whether the microphone data includes wake-up-word data 310. When the wake-up-word data 310 coincides with more than one of the plurality of vehicle cabin zones 122, such as with the wake-up-word data 320 of driver front zone 122-04 and the wake-up-word data 310 of the passenger front zone 122-01.

The determination of whether wake-up-word data of one zone 122-01 coincides with other wake-up-words of other zones 122-02, 122-03, and 122-04 may be based on time stamp data, such as ts₁ for wake-up-word 310, and ts₂ for wake-up word 320. Each of the wake-up-word data 310 and 320 may include a duration (taking into consideration the rate at which a vehicle passenger speaks the word). In the example of FIG. 3, the wake-up-word 310 and wake-up-word 320 are indicated as overlapping, or coincident, with one another, indicating that more than one of the vehicle cabin zones 122-01 to 122-04 include passengers engaging in a voice command sequence.

In FIG. 3, wake-up-word 310 may be followed by microphone data 124-01 including voice command data 312, and wake-up-word 320 may be followed by microphone data 124-04 including voice command data 322. Upon detection, the voice command control unit 110 may process the voice command data 312 and 322 to produce respective vehicle device commands. That is, the voice command control unit 110 may reduce the voice data contained by the voice command data 312 to render vehicle device commands capable of execution by respective vehicle devices.

For example, the vehicle device commands may be directed to the vehicle environmental controls or the vehicle entertainment controls (such as radio station, satellite station, playback title selection, channel selection, volume control, etc.).

To diminish the noise level of other zones 122-02 and 122-03, these channels may be declared as “dead data channels,” as indicted by the dashed lines. The voice command control unit 110 actively monitors for voice command data 312 and 322 of live channels associated with the passenger front zone 122-01 and driver front zone 122-04. Also, though the channels may be declared as “dead data channels,” the voice command control unit 110 may utilize the microphone data 124-02 and 124-03 for noise cancellation and/or mitigation purposes for monitoring for the voice command data 312 and 322. In the alternative, the voice command control unit 110 may discard and/or disregard microphone data 124-02 and 124-03 relating to the passenger rear zone 122-02 and the driver rear zone 122-03.

Following the receipt and processing of the live channels 122-01 and 122-04, the voice command control unit 110 may remove the “dead data channel” designation of the passenger rear zone 122-02 and the driver rear zone 122-03 to continue monitoring the microphone data 124-01 through 124-04 for wake-up-word data.

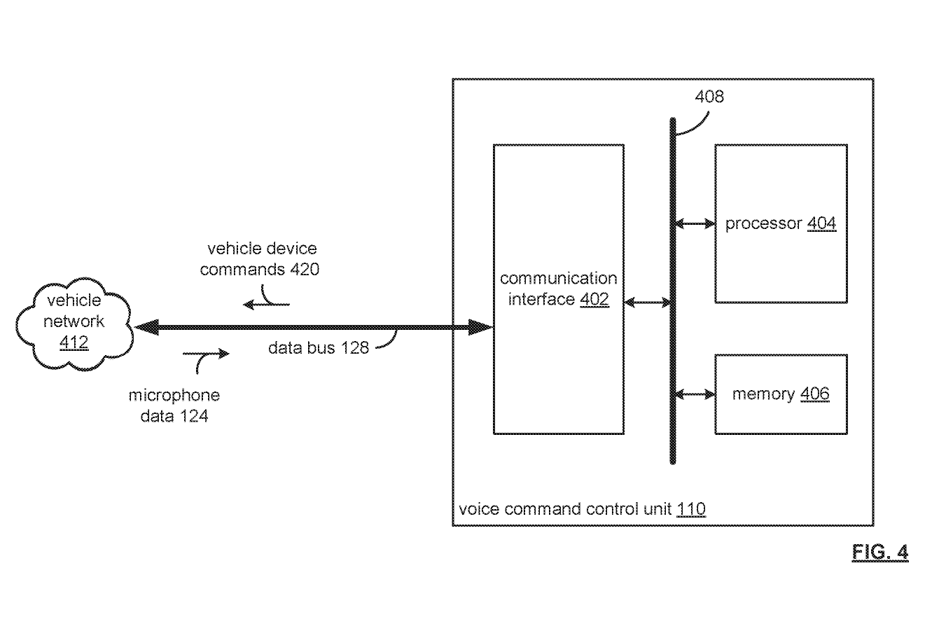

FIG. 4 illustrates a block diagram of the vehicle control unit 110 of FIGS. 1 and 2. The vehicle control unit 110 may include a communication interface 402, a processor 404, and memory 406, that are communicably coupled via a bus 408. The vehicle control unit 110 may provide an example platform for the device and methods described in detail with reference to FIGS. 1-6.

The processor 404 can be a conventional central processing unit or any other type of device, or multiple devices, capable of manipulating or processing information. As may be appreciated, processor 404 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory (and/or memory element) 406 may be communicably coupled to the processor 404, and may operate to store one or more modules described herein. The modules can include instructions that, when executed, cause the processor 404 to implement one or more of the various processes and/or operations described herein.

The memory and/or memory element 406 may be a single memory device, a plurality of memory devices, and/or embedded circuitry of the processor 404. Such a memory device may be a read-only memory, random access memory, volatile memory, non-volatile memory, static memory, dynamic memory, flash memory, cache memory, and/or any device that stores digital information. Furthermore, arrangements described herein may take the form of a computer program product embodied in one or more computer-readable storage medium having computer-readable program code embodied, e.g., stored, thereon. Any combination of one or more computer-readable media may be utilized. The computer-readable medium may be a computer-readable signal medium or a computer-readable storage medium.

The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device. Program code embodied on a computer-readable medium may be transmitted using any appropriate medium, including but not limited to wireless, wireline, optical fiber, cable, RF, etc., or any suitable combination of the foregoing.

The memory 406 is capable of storing machine readable instructions, or instructions, such that the machine readable instructions can be accessed and/or executed by the processor 404. The machine readable instructions can comprise logic or algorithm(s) written in programming languages, and generations thereof, (e.g., 1GL, 2GL, 3GL, 4GL, or 5GL) such as, for example, machine language that may be directly executed by the processor 404, or assembly language, object-oriented programming (OOP) such as JAVA, Smalltalk, C++ or the like, conventional procedural programming languages, scripting languages, microcode, etc., that may be compiled or assembled into machine readable instructions and stored on the memory 406. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 404 includes more than one processing device, the processing devices may be centrally located (e.g., directly coupled together via a wireline and/or wireless bus structure) or may be distributed located (e.g., cloud computing via indirect coupling via a local area network and/or a wide area network). Further note that when the processor 404 implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry.

Still further note that, the memory 406 stores, and the processor 404 executes, hard coded and/or operational instructions of modules corresponding to at least some of the steps and/or functions illustrated in FIGS. 1-6.

The vehicle control unit 110 can include one or more modules, at least some of which are described herein. The modules may be considered as functional blocks that can be implemented in hardware, software, firmware and/or computer-readable program code that perform one or more functions.

A module, when executed by a processor 404, implements one or more of the various processes described herein. One or more of the modules can be a component of the processor(s) 404, or one or more of the modules can be executed on and/or distributed among other processing systems to which the processor(s) 404 is operatively connected. The modules can include instructions (e.g., program logic) executable by one or more processor(s) 404.

The communication interface 402 generally governs and manages the data received via a vehicle network 412, such as environmental-control data microphone data 124 provided to the vehicle network 212 via the data bus 128. There is no restriction on the present disclosure operating on any particular hardware arrangement and therefore the basic features herein may be substituted, removed, added to, or otherwise modified for improved hardware and/or firmware arrangements as they may develop.

The vehicle control unit 110 may operate to, when wake-up word data, conveyed via the microphone data 124, of more than one of respective zones coincide with one another, monitor respective microphone data 124 for voice command data from each of the more than one of the respective ones of the vehicle cabin zones. Upon detection, the vehicle control unit 110 can process the voice command data to produce vehicle device commands 420. The vehicle device commands 420 may be transmitted using the communication interface 402, via a vehicle network 412, to effect the voice command data 420.

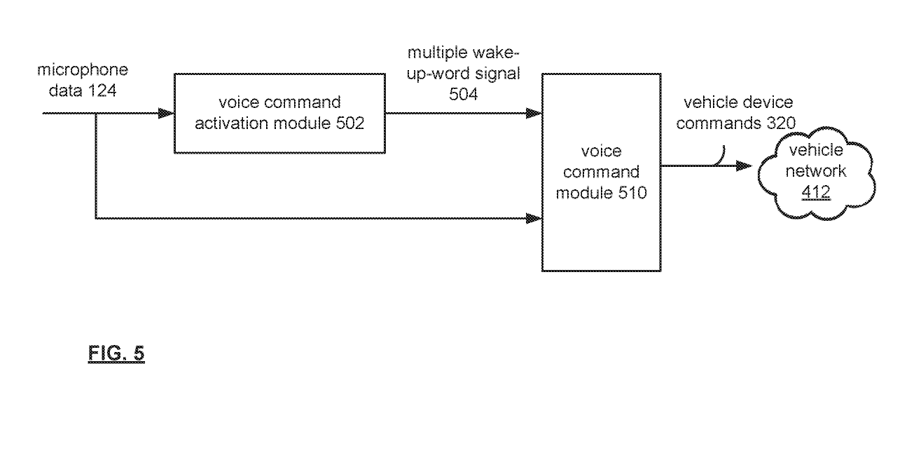

FIG. 5 illustrates a functional block diagram of the vehicle control unit 110 for generating vehicle device commands 420 from voice commands provided via the microphone data 124. The vehicle control unit 110 may include a voice command activation module 502 and a voice command module 510.

The voice command activation module 502 may include instructions that, when executed by the processor 404, cause the processor 404 to monitor microphone data 124. The microphone data 124 may be produced by a plurality of microphones, such as digital microphones that may receive an analog input (such as a wake-up-word, voice command, etc.), a beamforming microphone, etc., that may receive audio from vehicle cabin zones and produce digital output data such as microphone data 124.

The voice command activation module 502 may include instructions that, when executed by the processor 404, cause the processor 404 to determine whether the microphone data 124 for the each of the respective ones of the vehicle cabin zones include wake-up-word data, and when more than one of the respective ones of the vehicle cabin zones include wake-up-word data, to receive the wake-up-word data for the respective vehicle cabin zones, and determine whether the wake-up-word data coincides with one another in time. In this respect, the voice command control unit 110 may detect multiple overlapping and/or coincident wake-up-words within the vehicle, such as “wake up,” “computer,” “are you there?”, etc.

When more than one wake-up-word data is overlapping and/or coincident with one another, the voice command activation module 502 may generate a multiple wake-up-word signal to indicate an overlapping and/or coincident condition, which may also operate to identify the vehicle cabin zones (such as an address of a respective microphone, a directional identifier via a beamforming microphone, etc.).

Voice command module 510 may include instructions that, when executed by the processor 404, cause the processor 404 to monitor the microphone data 124 for voice command data from the each of the more than one of the respective ones of the plurality of microphones. Such monitoring may be based on the multiple wake-up-word signal 504, which may identify the vehicle cabin zones 122-01 to 122-04 (FIGS. 1 & 2) and respective microphone devices (addresses and/or beamforming receive directions).

Upon detecting the voice command data from more than one of the respective vehicle cabin zones, the voice command module 510 may include further instructions that, when executed by the processor 404, cause the processor 404 to process the voice command data to produce respective vehicle device commands 320, which may be transmitted, via a vehicle network 412, for effecting the voice command data from the more than one of the respective ones of the vehicle cabin zones.

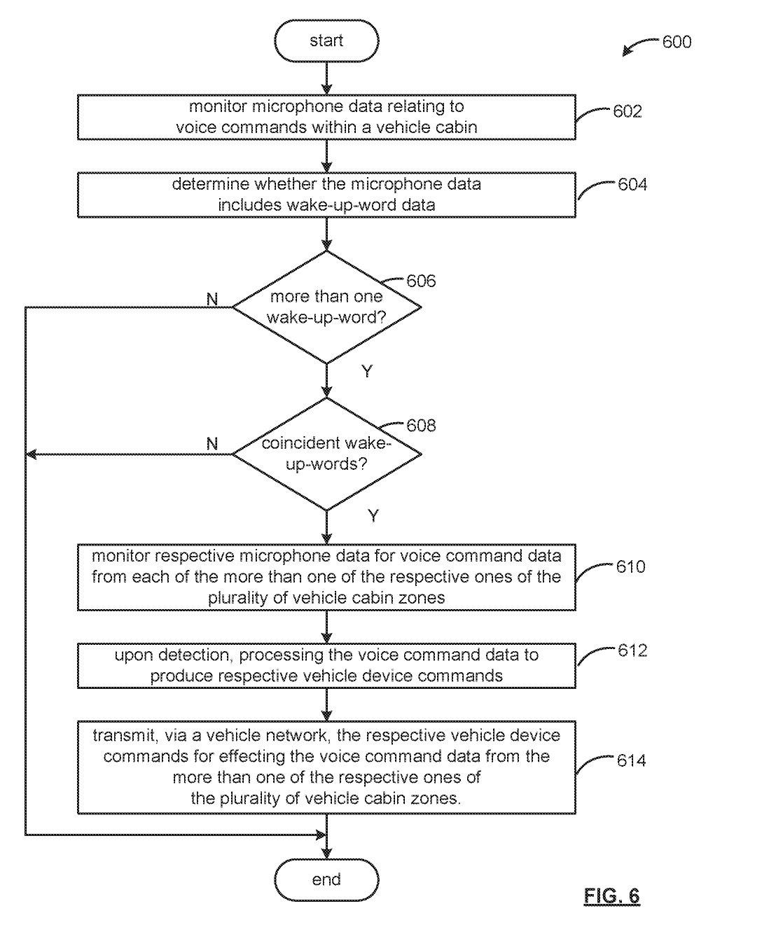

FIG. 6 is an example process 600 for voice command recognition in a vehicle cabin environment based on coincident wake-up-words. In this respect, multiple occupants and/or passengers of a vehicle cabin may initiate a voice command with a wake-up-word without delay and/or confusion in a voice command control unit 110 to carry-out processing of the voice command.

At operation 602, microphone data may be monitored relating to voice commands within a vehicle cabin. A voice command may include wake-up-word data based upon an occupants spoken word (such as “computer,” “wake-up,” “are you there Al?, etc.). As may be appreciated, a user may provide a single wake-up-word or several wake-up-words for use with a voice command control unit 110.

At operation 604, a determination may be made as to whether the microphone data includes wake-up-word data, and at operation 606, when there is more than one wake-up-word data occurrences (such as “computer,” “wake-up,” “are you there Al,” and/or combinations thereof), a determination may be made at operation 608 as to whether the wake-up-word data is coincident with one another. In other words, that multiple passengers of a vehicle effectively spoke over one another when they uttered their respective wake-up-word to invoke a subsequent voice command.

When more than wake-up-words are coincident, the operation provides at operation 610 that respective microphone data (such as identified as including coincident wake-up words) may be monitored for voice command data from respective vehicle cabin zones. In this respect, a voice command control unit may operate to process multiple instances of wake-up-words substantially in parallel, as contrasted to a “first-in, first-out” basis. Non-parallel processing adds a delayed response to an occupant's voice command, which may be misconstrued as not received or “heard” by the vehicle control unit. Accordingly, in operation 612, upon detection, voice command data may be processed to produce respective vehicle device commands, such as environmental control commands, entertainment device commands, navigation commands, etc.

In operation 614, the respective vehicle device commands may be transmitted, via a vehicle network, for effecting the voice command data from the more than one of the respective ones of the plurality of vehicle cabin zones. That is, the wake-up-words, though coincident, prompt sufficient response by carrying out the vehicle device commands, eliminating frustration and needless command repetition by vehicle passengers.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

Various embodiments are shown in FIGS. 1-6, but the embodiments are not limited to the illustrated structure or application. As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences.

As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.” As one of ordinary skill in the art will further appreciate, the term “compares favorably,” as may be used herein, indicates that a comparison between two or more elements, items, signals, et cetera, provides a desired relationship. For example, when the desired relationship is that a first signal has a greater magnitude than a second signal, a favorable comparison may be achieved when the magnitude of the first signal is greater than that of the second signal, or when the magnitude of the second signal is less than that of the first signal.

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage medium, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
monitoring microphone data relating to voice commands within a vehicle cabin;
determining whether the microphone data includes wake-up-word data;
when the wake-up-word data relates to more than one of a plurality of vehicle cabin zones:
when the wake-up-word data of the more than one of the respective ones of the plurality of vehicle cabin zones coincide with one another:
monitoring respective microphone data for voice command data from each of the more than one of the respective ones of the plurality of vehicle cabin zones;
upon detection, processing the voice command data to produce respective vehicle device commands; and
transmitting, via a vehicle network, the respective vehicle device commands for effecting the voice command data from the more than one of the respective ones of the plurality of vehicle cabin zones.

2. The method of claim 1, wherein:
data channels of the more than one of the respective ones of the plurality of vehicle cabin zones are designated as live data channels; and
data channels of remaining ones of the plurality of vehicle cabin zones are designated as dead data channels.

3. The method of claim 1 further comprising:
diminishing a pick-up sensitivity of a remainder of the plurality of vehicle cabin zones.

4. The method of claim 3, wherein the diminishing the pick-up sensitivity of the remainder of the plurality of microphones comprises at least one of:
discarding microphone data for the remainder of the plurality of vehicle cabin zones; and
increasing a pick-up sensitivity parameter for the respective ones of the plurality of the more than one of the plurality of vehicle cabin zones.

5. The method of claim 1, wherein a plurality of microphones generates the microphone data.

6. The method of claim 1, wherein each of the plurality of vehicle cabin zones includes a respective one of the plurality of microphones and wherein the each of the respective ones of the plurality of microphones is proximal a vehicle occupant location within the vehicle cabin.

7. The method of claim 1, wherein a beamforming microphone generates the microphone data.

8. A method comprising:
monitoring microphone data produced by a respective plurality of microphones in a vehicle cabin;
determining whether the microphone data for each of the respective ones of the plurality of microphones includes wake-up-word data;
when at least first microphone data and second microphone data of respective ones of the plurality of microphones include wake-up-word data:
determine whether the wake-up-word data of each of the at least first microphone data and the second microphone data coincide with one another in time;
when the wake-up-word data of each of the at least first microphone data and the second microphone data coincide with one another in time:
monitoring the microphone data for voice command data from the each of the respective ones of the plurality of microphones that include wake-up-word data; and
upon detecting the voice command data from the each of the respective ones of the plurality of microphones, processing first voice command data and second voice command data to produce a first vehicle device command and a second vehicle device command; and
transmit the first vehicle device command and the second vehicle device command for effecting the voice command data from the each of the respective ones of the plurality of microphones.

9. The method of claim 8, wherein:
data channels of the more than one of the respective ones of the plurality of microphones are designated as live data channels; and
data channels of remaining ones of the plurality of microphones are designated as dead data channels.

10. The method of claim 8 further comprising:
diminishing a pick-up sensitivity of a remainder of the plurality of microphones.

11. The method of claim 10, wherein the diminishing the pick-up sensitivity of the remainder of the plurality of microphones comprises at least one of:
discarding microphone data for the remainder of the plurality of microphones; and
increasing a pick-up sensitivity parameter for the respective ones of the plurality of the more than one microphones of the plurality of microphones.

12. The method of claim 8, wherein the processing the voice command data to produce respective vehicle device commands comprises a multiprocessing operation.

13. The method of claim 12, wherein the multiprocessing operation includes at least one of:
a master/slave operation;
a symmetric multiprocessing operation; and
a massively parallel processing operation.

14. The method of claim 8, wherein the each of the respective ones of the plurality of microphones being proximal a vehicle occupant location within the vehicle cabin.

15. A voice command control unit comprising:
a communication interface to service communication with a vehicle network;
a processor communicably coupled to the communication interface; and
memory communicably coupled to the processor and storing:
a voice command activation module including instructions that, when executed by the processor, cause the processor to:
monitor microphone data produced by each of respective ones of a plurality of microphones located in a vehicle cabin; and
determine whether the microphone data for the each of the respective ones of the plurality of microphones includes wake-up-word data;
when more than one of the respective ones of the plurality of microphones include wake-up-word data:
receive the wake-up word data for the respective ones of the plurality of microphones;
determine whether the wake-up-word data of the more than one of the respective ones of the plurality of microphones coincide with one another in time; and
when the wake-up-word data of the more than one of the respective ones of the plurality of microphones coincide with one another in time, produce a multiple wake-up-word signal; and
voice command module including instructions that, when executed by the processor, cause the processor to:
monitor the microphone data for voice command data from the each of the more than one of the respective ones of the plurality of microphones;
upon detecting the voice command data from the more than one of the respective ones of the plurality of microphones, process the voice command data to produce respective vehicle device commands; and
transmit, via a vehicle network, the respective vehicle device commands for effecting the voice command data from the more than one of the respective ones of the plurality of microphones.

16. The voice command control unit of claim 15, wherein:
data channels of the more than one of the respective ones of the plurality of microphones are designated as live data channels; and
data channels of remaining ones of the plurality of microphones are designated as dead data channels.

17. The voice command control unit of claim 15 further including instructions that, when executed by the processor, cause the processor to:
diminish a pick-up sensitivity of a remainder of the plurality of microphones.

18. The voice command control unit of claim 17, wherein the instructions that cause the processor to diminish the pick-up sensitivity of the remainder of the plurality of microphones comprises instructions to at least one of:
discard microphone data for the remainder of the plurality of microphones; and
increase a pick-up sensitivity parameter for the respective ones of the plurality of the more than one microphones of the plurality of microphones.

19. The voice command control unit of claim 15, wherein the instructions that cause the processor to process the voice command data to produce respective vehicle device commands comprises a multiprocessing operation.

20. The voice command control unit of claim 15, wherein the each of the respective ones of the plurality of microphones is proximal a vehicle occupant location within the vehicle cabin.
